(19) United States
(12) Patent Application Publication
(10) Pub. No.: US 2025/0300320 A1
(43) Pub. Date: Sep. 25, 2025

(54) MULTI-LOBED MEMBRANE AND/OR SODIUM-METAL-HALIDE AND/OR MOLTEN SALT BATTERIES INCLUDING SAID MULTI-LOBED MEMBRANE THEREIN

(71) Applicant: Inlyte Energy, Inc., San Leandro, CA (US)

(72) Inventors: Peter Barrow, Burton-on-Trent (GB); Justyna Minkiewicz, San Leandro, CA (US); Sophie Griggs, San Leandro, CA (US); Ali Mehranjani, San Leandro, CA (US); Tobias Juetting, San Leandro, CA (US); Katie Hanus, San Leandro, CA (US); Antonio Baclig, San Leandro, CA (US); William Gent, San Leandro, CA (US)

(73) Assignee: Inlyte Energy, Inc., San-Leandro, CA (US)

(21) Appl. No.: 19/089,712

(22) Filed: Mar. 25, 2025

Related U.S. Application Data
(60) Provisional application No. 63/569,224, filed on Mar. 25, 2024.

(51) Int. Cl. H01M 50/469; H01M 10/0562; H01M 10/39; H01M 50/434; H01M 50/474

(52) U.S. Cl. CPC H01M 50/469; H01M 10/0562; H01M 10/399; H01M 50/434; H01M 50/474; H01M 2300/0074

(57) ABSTRACT

A separator for a metal conversion battery can include an alkali metal-conducting ceramic material, where at least five convex curves and at least five concave curves can define a closed transverse cross-sectional profile of the separator, where the transverse cross-sectional profile can be perpendicular to a longitudinal axis of the separator.

### CROSS-REFERENCE TO RELATED APPLICATIONS

This application claims the benefit of U.S. Provisional Application No. 63/569,224 filed 25 Mar. 2024, which is incorporated in its entirety by this reference.

### TECHNICAL FIELD

This invention relates generally to the metal conversion battery field, and more specifically to a new and useful battery separator in the conversion battery field.

### BRIEF DESCRIPTION OF THE FIGURES

FIG. 1 is a schematic representation of a cross-section of a variant of the system.

FIG. 2 is an illustrative example of a variant of a variant of the system.

FIG. 3 is a dimensional example of a variant of a cross-section of the lobed separator.

FIG. 4 is a dimensional example of a variant of a cross-section of the lobed separator.

FIG. 5A-5B are examples of variants of the lobed separator.

FIG. 6 is an illustrative example of a variant of regions of the lobed separator.

FIG. 7 is a dimensional example of a variant of the transition region of the lobed separator.

FIGS. 8A-8D are illustrative examples of variants of cross-sectional profiles of electrode compartments of the lobed separator.

FIG. 9 is an illustrative example of a variant of of the electrochemical cell.

FIGS. 10A and 10B are illustrative examples of variants of biasing supports.

FIG. 11 is a dimensional example of a variant of a cross-section of the lobed separator.

FIG. 12 is a schematic representation of a cross-section of a variant of the system.

### DETAILED DESCRIPTION

The following description of the embodiments of the invention is not intended to limit the invention to these embodiments, but rather to enable any person skilled in the art to make and use this invention.

### 1. Overview

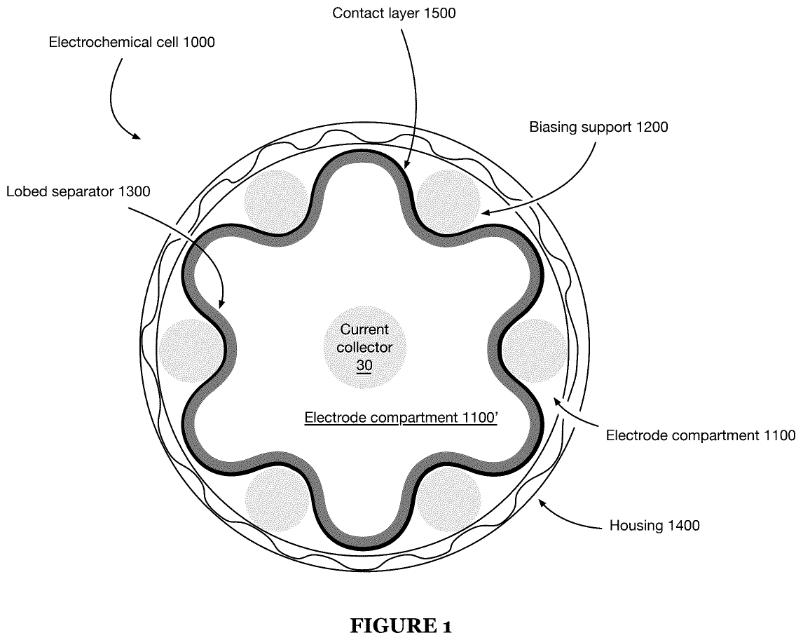

As shown for example in FIG. 1, an electrochemical cell can include: electrode compartments 1100,1100′; biasing support 1200; a lobed separator 1300; a housing 1400; a contact layer 1500; and/or other suitable components. The electrochemical cell preferably functions to store and release energy. The electrochemical cell is preferably a molten battery (e.g., molten salt such as sodium sulphur, lithium sulphur, sodium metal-halide, etc.; molten metal such as magnesium-antimony, lead-antimony, etc.; metal conversion; etc.). However, the electrochemical cell can include other battery chemistries and/or the lobed separator thereof can be used with other electrochemical cells.

The electrochemical cell can be combined to form battery modules and/or battery packs (e.g., where each electrochemical cell can be substantially the same and/or can be formed in a manner as described herein, where a battery pack can include a plurality of different electrochemical cells, etc.). For example, a battery pack can include an array (e.g., grid, hexagonal array, etc.) of electrochemical cells (e.g., with cylindrical, prismatic, tubular, extruded, etc. batteries hexagonally close-packed).

### 2. Example

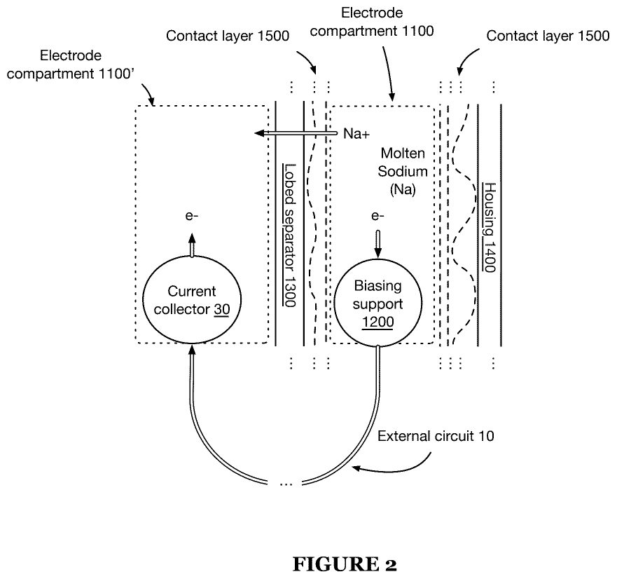

In an illustrative example, the system can include a molten salt battery contained within a cylindrical housing. A lobed separator can divide the space defined by the housing into an anode compartment and a cathode compartment that include molten sodium (Na) and iron chloride (FeCl₂) respectively (while in a charged or charging state). The separator can have a lobed cross-section, for example a hexalobe or octa-lobe-shaped cross-section. During discharging or charging, biasing supports on opposite sides of the separator can facilitate electron flow between the anode and the cathode via an external circuit (e.g., via current collectors connected to the cathode and anode; example shown in FIG. 2). In this variant, biasing supports on the outside of the separator can each be within an indentation defined between lobes of the separator and can apply contact forces to the outer surface of each separator indentation. The separator can have an extruded cross-sectional shape which is closed at one end, a hexalobe through a middle section, and transition to a circular or elliptical opening near an opposite end via a profile transition.

### 3. Technical Advantages

Variants of the technology can confer one or more advantages over conventional technologies.

First, variants of the technology can improve the power output from an electrochemical battery, such as a metal conversion (e.g., molten salt, molten sodium, etc.) battery. Traditional molten sodium battery separators normally have a circular cross-section to resist bursting of the separator during operation (e.g., charging and/or discharging) of the battery. However, the resultant cylindrical surface of the separator can have a relatively low area compared to batteries with non-circular separator cross-sections. By using a lobed separator with a high (e.g., 5 or more) number of lobes, the increased surface area of the separator can enables a higher flow rate of ions from the anode to the cathode, which increases electron flow across current collectors as well. This increased flow can improve energy and/or power output of a battery without changes to the overall battery size and/or electrode composition. The inventors have found that variants of the hexalobe design can improve power density of the electrochemical battery over similarly sized conventional designs by over 8%.

Second, variants of the technology can achieve a high surface area without significantly compromising burst pressure. By using a lobed architecture with a high number of curved lobes (e.g., 5 or more), the separator can resist a higher pressure differential across the separator (e.g., while the electrochemical cell is fully charged, etc.). In variants, the usage of a double-curved cross-sectional shape (e.g., with both curved lobes and curved indentations, without linear or noncurved regions, etc.) can enable the separator to achieve optimal resistance to both positive and negative pressure differentials and/or can decrease a risk or forming particular weak points.

Third, variants of the technology can increase the amount of electrode material used within the electrochemical cell. In variants where a cylindrical electrochemical cell is used, a separator with a high number of lobes (e.g., 5 or more) can more readily fit such a shape than a lobed separator with a lower number of lobes (e.g., 4 or fewer). Additionally or alternatively, due to the high strength (e.g., higher burst pressure for a given thickness) of the multi-lobe design, a thinner separator can be used, increasing the volume of electrode compartment(s) overall and/or reducing the electrical resistance of the cell.

Fourth, variants of the technology can enable the usage of a wider variety of separator materials for a lobed separator while achieving a high burst strength to internal pressure. For example, because a curved-lobe separator design resists burst pressure particularly well compared to other non-circular separator cross-sections, weaker separator materials can be used without significantly reducing burst pressure.

Sixth, the usage of a cylindrical housing can be easier and/or less expensive to manufacture than other housing shapes (e.g., squares, etc.), can facilitate the construction and/or manufacture of more efficient and/or reliable seals with other components of a battery cell (for example, there are no corners to accommodate as is required for a polygonal cannister), and/or can confer other possible technical advantages. The implementation of a separator with many lobes (e.g., 5 or more) can enables circular housings to be efficiently used, as a lobed separator with a high number of lobes can better approximate a circle than lobed separators with a low number of lobes (e.g., 4 or fewer).

However, further advantages can be provided by the system and method disclosed herein.

### 4. Electrochemical Cell

As shown for example in FIG. 1, an electrochemical cell can include: electrode compartments 1100, 1100′; biasing support 1200; a lobed separator 1300; a housing 1400; a contact layer; and/or other suitable components. The electrochemical cell preferably functions to store and release energy. The electrochemical cell can be combined to form battery modules and/or battery packs (e.g., where each electrochemical cell can be substantially the same and/or can be formed in a manner as described herein, where a battery pack can include a plurality of different electrochemical cells, etc.). For example, a battery pack can include an array (e.g., grid, hexagonal array, etc.) of electrochemical cells (e.g., with cylindrical, prismatic, tubular, extruded, etc. batteries hexagonally close-packed).

The electrochemical cell is preferably substantially rod-shaped (e.g., includes a cylindrical housing), but can alternatively be any other suitable shape (e.g., prismatic housing such as square prism, rectangular prism, hexagonal prism, triangular prism, etc.).

The depth (also referred to as height) of the electrochemical cell (e.g., length along a longitudinal direction) can be between about 5 cm and 500 cm or any range or value therebetween (e.g., 10 cm, 20 cm, 30 cm, 36 cm, 40 cm, 50 cm, 75 cm, 100 cm, 150 cm, 200 cm, 250 cm, 300 cm, 400 cm, etc.). The depth can alternatively be less than 5 cm or greater than 500 cm.

The span (e.g., maximum span, minimum span, length or width perpendicular to the longitudinal direction, etc.) of the electrochemical cell can be 1 cm, 2 cm, 4 cm, 8 cm, 9 cm, 10 cm, 11 cm, 12 cm, 15 cm, 20 cm, 30 cm, within an open or closed range bounded by the aforementioned values (and/or a value within 10% of the aforementioned values) and/or any other suitable span.

The electrochemical cell can have a current capacity (e.g., at a 4 hour rate, at a 10 hour rate, nominal capacity, etc.) between 10 Ah and 2000 Ah or any range or value therebetween (e.g., 20 Ah, 50 Ah, 100 Ah, 200 Ah, 300 Ah, 325 Ah, 350 Ah, 375 Ah, 400 Ah, 500 Ah, 600 Ah, 750 Ah, 800 Ah, 900 Ah, etc.). The current capacity can alternatively be less than 10 Ah or greater than 2000 Ah.

The electrochemical cell can have an energy capacity between 300 Wh-4500 Wh or any range or value therebetween (e.g., 400 Wh, 500 Wh, 550 Wh, 600 Wh, 625 Wh, 650 Wh). The energy capacity can alternatively be less than 300 Wh or greater than 4500 Wh.

The electrochemical cell can have a volumetric energy density of 50 Wh/L, 100 Wh/L, 150 Wh/L, 200 Wh/L, 250 Wh/L, 275 Wh/L, 280 Wh/L, 290 Wh/L, 300 Wh/L, 400 Wh/L, 500 Wh/L, within an open or closed range bounded by the aforementioned values, and/or any other suitable volumetric energy density. The electrochemical cell can have a gravimetric energy density of 50 Wh/kg, 100 Wh/kg, 150 Wh/kg, 175 Wh/kg, 200 Wh/kg, 215 Wh/kg, 225 Wh/kg, 250 Wh/kg, 300 Wh/kg, 500 Wh/kg, within an open or closed range bounded by the aforementioned values, and/or any other suitable gravimetric energy density.

The electrochemical cell and/or elements thereof can be operated (e.g., cycled, charged and/or discharged) at high temperatures (e.g., 100-400° C., within a range bounded by the aforementioned temperatures, within a subset of temperatures therein, etc.).

The electrode compartment 1100 functions to contain an electrode which can undergo an electrochemical reaction. The electrode compartment 1100 can include current collectors 30 which can link each electrode to an external circuit 10.

The current collector(s) preferably functions to conduct electrons into and out of the electrode(s). For instance, a cathode current collector can conduct electrons between a cathode and external device(s) and an anode current collector can conduct electrons between an anode and external device(s). The cathode current collector and anode current collector can be made from the same or different materials. The current collectors can be foil, foam, mesh, rod, tube, carbon coated, wire, plate, and/or be any type of current collector. The current collectors are typically made from carbon steel (e.g., mild steel, high-tensile steel, high-carbon steel, etc.), stainless steel, and/or alloy steels. However, the current collectors can be made of any material (e.g., carbonaceous materials such as carbon nanotubes, graphite, graphene, etc.; metals such as brass, copper, aluminium, nickel, etc.; etc.). Typically, one current collector is arranged inside the separator and one current collector is outside the separator. Typically (but not necessarily), the cell housing functions as the current collector for the outer electrode compartment 1100.

The electrochemical cell preferably includes two electrochemical compartments (e.g., one inside the lobed separator and one between an outer surface of the lobed separator and the housing). However, an electrochemical cell can include a plurality of electrochemical s (e.g., where each electrochemical compartment is separated by a separator). In a first variant, an inner compartment (e.g., inside a volume defined by a separator) can be the cathode and the outer compartment can be the anode. In a second variant, the inner compartment (e.g., inside a volume defined by a separator) can be the anode and the outer compartment can be the cathode. The electrochemical cell can include any other electrochemical compartment configuration and/or arrangement (e.g., a planar separator dividing an internal volume of a housing into compartments). The outer electrode compartment 1100 and the inner electrode compartment 1100′ (often but not necessarily the anode and cathode electrochemical compartments respectively) can have a volume ratio of 10:1, 5:1, 3:1, 2:1, 3:2, 1:1, 2:3, 1:2, 1:3, 1:5, 1:10, and/or any other suitable ratio.

Each electrode compartment 1100 can contain an electrode (e.g., a cathode or an anode, etc.) and a set of biasing supports.

The electrode compartment 1100 can contain a cathode or an anode. In a first example, anode materials can include pure sodium, a sodium-lead alloy, a sodium-tin alloy, a sodium-bismuth alloy, a sodium-tin-antimony alloy, titanium-based materials, metal sulfides, and/or any other suitable material or combination of materials. In a second example, cathode materials preferably include one or more metals with suitable electroreactivity including (but not limited to) iron, nickel, copper, manganese, vanadium, titanium, cobalt, chromium, zinc, aluminium, and/or combinations thereof, in combination with an alkali metal salt including (but not limited to) sodium chloride, sodium fluoride, sodium iodide, sodium bromide, potassium chloride, lithium chloride, and/or other alkali metal halide. However, the cathode materials can additionally or alternatively include: lead antimony alloys, lead bismuth alloys, sulfur, sulfur with carbon additives, transition metal polysulfides, sodium polysulfides, metal salts, and/or any other suitable materials or combinations of materials. As an illustrative example, a cathode active material can include a mixture of iron and nickel (where in a charged state the iron can form iron chloride and the nickel can form nickel chloride) in a ratio (e.g., mass ratio, atomic ratio, etc.) of between about 8:2 (e.g., about 80% Fe and about 20% Ni, where percentages can refer to weight percent, particle count, stoichiometric ratio, volume ratio, or other suitable ratio) and 100:1 (e.g., essentially entirely composed of, consisting essentially of, including essentially only, etc. iron). In another example, a cathode active material can include metals and the alkali metal halide in a ratio (e.g., mass ratio, atomic ratio, etc.) of between about 4:6 (e.g., about 40% metal and about 60% alkali metal halide, where percentages can refer to weight percent, particle count, stoichiometric ratio, volume ratio, or other suitable ratio) and 8:2.

However, the electrode compartment 1100 may be otherwise configured.

The contact layer 1500 can function as a wick for molten sodium. The contact layer 1500 can additionally or alternatively function to provide electric contact to the separator to facilitate generating sodium metal (e.g., during initial charging). The contact layer 1500 can include a mesh (e.g., a steel mesh), a shim, centering rings, and/or any other components. The contact layer 1500 can include a single layer and/or a plurality of layers. The contact layer 1500 can be flexible or rigid. The contact layer 1500 and/or components thereof can have a thickness of under 0.0005″, 0.001″, 0.002″, 0.005″, 0.01″ and/or can have a thickness defined by any other suitable upper bound. The contact layer is preferably electrically conductive. For instance, the contact layer can be made from carbon steel (e.g., mild steel, high-tensile steel, high-carbon steel, etc.), stainless steel, alloy steels, carbonaceous materials such as carbon nanotubes, graphite, graphene, etc.; metals such as brass, copper, aluminium, nickel, and/or other suitable material(s). However, the contact layer can have other suitable electrical conductivity (e.g., one or more contact layers can be electrically insulating).

In a first variant, the contact layer 1500 can be between the biasing support 1200 and the housing. In a second variant, the contact layer 1500 can be between the biasing support 1200 and the lobed separator 1300. In a third variant, the contact layer 1500 can be within the housing 1400 (e.g., a corrugated sheet, etc.). In a fourth variant, a combination of the preceding three variants can be used in a combination of arrangements (e.g., a contact layer in contact with a separator and a corrugated sheet proximal to a housing surface as shown for instance in FIG. 2).

In a first variant, the contact layer 1500 can maintain separation between a biasing support and the separator to facilitate fluid flow of the molten sodium. In a second variant, the contact layer 1500 can distribute forces such as to achieve constant pressure distribution and/or redistribute pressure across the ceramic separator. In a third variant, the contact layer 1500 can thermally and/or electrically interface (e.g., conductively connect, insulate from one another, etc.) components. In a fourth variant, the contact layer 1500 can retain a position of components relative to each other.

In a first example, the contact layer 1500 can include a flexible sheet between the biasing support and an outer surface of the lobed separator. In a second example, the contact layer 1500 can include a steel mesh between the biasing support and an outer surface of the lobed separator. In a third example, the contact layer 1500 can include a flexible sheet and steel mesh in series between the biasing support and the lobed separator (e.g., with the flexible sheet outside or inside the steel mesh).

The biasing support 1200 functions to support the separator, ensure better and/or more conformal contact between the contact layer and a surface of the separator, and/or reduce the electrical resistance between the housing and a surface of the separator. In some variants, the biasing support 1200 can optionally be a current collector 30, where the biasing support can connect to an external circuit 10 (e.g., being powered by the battery, etc.). However, the biasing support can additionally and/or alternatively be connected in any suitable manner.

The biasing support 1200 can be and/or include a rod, a tube (e.g., a rod with an internal opening), a foil, a scroll, a wire, a foam, a mesh, a spiral, and/or any other suitable shape.

The biasing support(s) 1200 can be rigid (e.g., can deform <1%). Additionally or alternatively, one or more biasing supports can alternatively deform elastically (e.g., can deform 1%-90% without plastically deforming, etc.), and/or otherwise deform. In some variants (e.g., for sufficiently flexible biasing supports), the biasing support can act as the contact layer (e.g., can conform to the active surface of the separator). In one example of such a variant, no separate contact layer can be provided between the biasing support and the separator. In another example of such a variant, a shim can be provided between the flexible biasing support and the separator (e.g., to further enhance electrical contact between the separator and the biasing support).

The biasing support(s) 1200 can be steel (e.g., mild steel, stainless steel, carbon steel, etc.), copper, aluminum, copper, nickel, titanium, carbon-coated copper, carbon-coated aluminum, and/or any other suitable material.

The biasing support 1200 can be solid or hollow. The biasing supports can collectively make up between 1%-20% or any range or value therebetween (e.g., 1%, 2%, 5%, 10%, 20%) of the volume of an electrode compartment which they are included in.

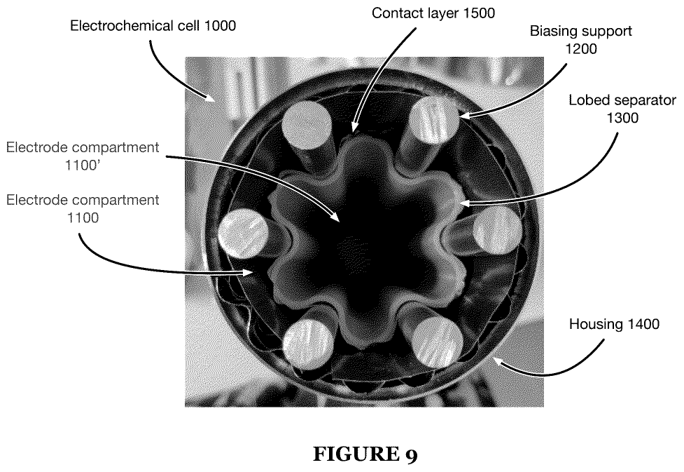

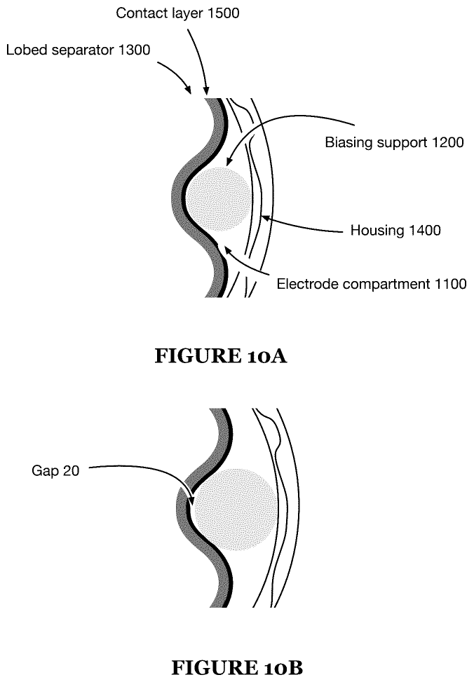

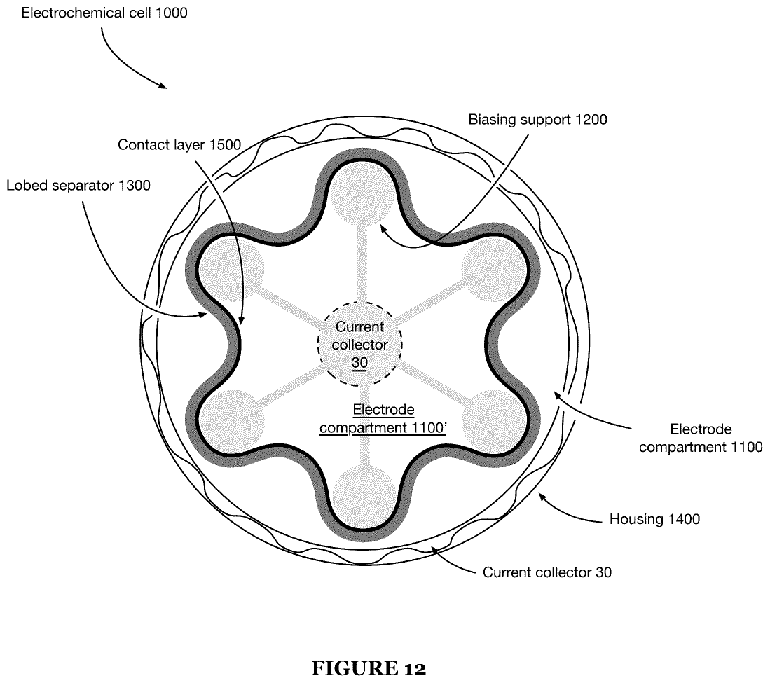

The radius of a biasing support 1200 is preferably between about 5 mm and 25 mm (e.g., 4 mm, 5 mm, 7 mm, 9 mm, 10 mm, 10.7 mm, 11 mm, 15 mm, 17 mm, 19 mm, 20 mm, 22.5 mm, etc.). However (e.g., depending on a size of an electrochemical cell), larger or smaller biasing supports could be used. In variants where the biasing support 1200 is positioned inside of a lobe or indentation of a separator (as shown for example in FIG. 10A), the biasing support 1200 preferably has an equal or smaller radius than the lobe radius of curvature or indentation radius of curvature (which can be beneficial ensuring good contact between the contact layer and the separator into the valley). However, the biasing support can have a larger radius to a lobed radius of curvature or indentation radius of curvature (as shown for example in FIG. 1, FIG. 9, FIG. 10B, or FIG. 12).

In an example, the biasing support 1200 radius can be larger (e.g., 1% larger, 2% larger, 5% larger, 10% larger, etc.) than a lobed separator outer surface radius of curvature, such that the biasing support applies a set of alignment forces to a set of points in between a minimum radius and a maximum radius (e.g., to the side of the lobe, etc.). In this example, the biasing support and the lobed separator can cooperatively define a gap 20 between the lobed separator and the biasing support (e.g., example shown in FIG. 10B).

Each electrode compartment can contain 1, 2, 3, 4, 5, 6, 7, 8, 9, 12, 16, 24, and/or any other suitable number of biasing supports 1200. Typically, the number of biasing supports will be equal to or more than the number of indentations (e.g., concave regions) of the separator.

In a first variant, the location of the biasing support 1200 can be around the perimeter of the outside of the lobed separator (e.g., a set of longitudinal rods, each, at an indentation of the lobed separator, etc.). In an example of the first variant, the biasing supports can be located within a concave curve region between two lobes (e.g., convex curves).

In a second variant, the location of the biasing support 1200 can be inside the lobes (e.g., convex curves) of the lobed separator (e.g., a set of longitudinal rods, each, at a lobe of the lobed separator; example shown in FIG. 12). In an example, the biasing supports can be located within a convex curve region between two indentations (e.g., concave curves).

The biasing support 1200 can apply a force directly or indirectly to the lobed separator. In a first example, the biasing support 1200 can apply a force to an indentation on the outer surface of the separator (e.g., to improve contact or conformation of the contact layer to the separator). In a second example, the biasing support 1200 can apply a force to a set of contact layers separating the biasing support from the lobed separator (e.g., example shown in FIG. 9, etc.).

The biasing supports 1200 are preferably non-overlapping radially (e.g., in a radial direction relative to a longitudinal axis of the lobed separator, pointing outward from a central axis of the lobed separator, etc.) relative to a longitudinal axis of the lobed separator (e.g., with one biasing support in an indentation, etc.). The biasing supports 1200 can have the same radius and/or cross-sectional area as each other but can alternatively have different cross-sectional areas. In one specific example, cylindrical biasing supports around a lobed separator have alternating diameters of about 10 mm and about 11 mm.

However, the biasing support 1200 may be otherwise configured.

The lobed separator 1300 (also referred to as a membrane or solid electrolyte) functions to facilitate the transfer of cations (e.g., Na⁺) between the anode and the cathode of the electrochemical cell (e.g., the battery) while hindering the transport of electrons. The lobed separator 1300 and/or portions thereof preferably has a hollow extruded shape (e.g., includes a longitudinal axis that is typically but not necessarily aligned with a gravity vector during operation of an electrochemical cell) sealed at one end (e.g., to define a volume within the hollow interior and cooperatively with the housing define a volume outside of the separator). After loading (e.g., with electrode materials, current collector, biasing support(s), etc.), the opened end of the separator can be sealed (e.g., via brazing, glass sealing, welding, soldering, fittings, etc.).

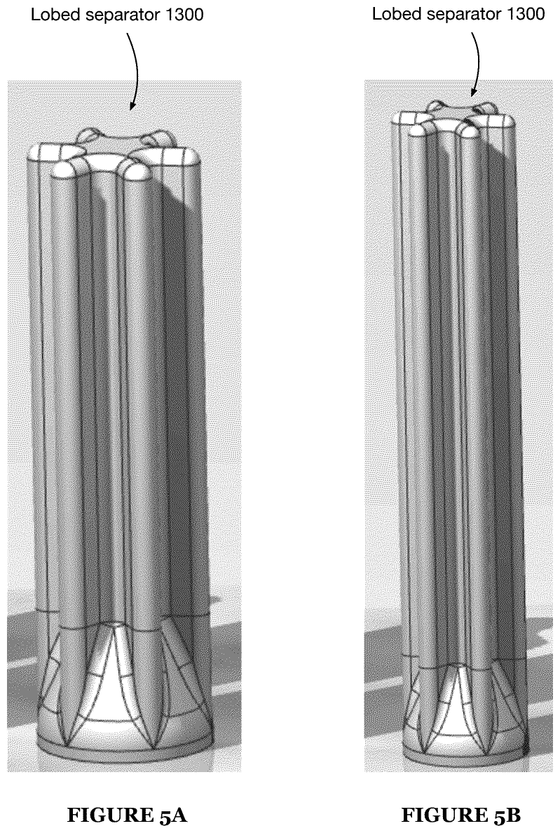

The lobed separator 1300 is preferably closed at a bottom end and open at a top end (e.g., examples shown in FIGS. 5A and 5B, etc.). In an example, the top end can include or be sealably connected to a closure assembly which can seal the top end.

The lobed separator 1300 can extend along the length of the electrochemical cell (e.g., 50%, 80%, 90%, 95%, 98%, 99% of the depth of the cell, etc.).

The lobed separator 1300 can be oriented along a central longitudinal axis of the electrochemical cell. In an example, a central longitudinal axis of the lobed separator is aligned along a central longitudinal axis of the housing.

The lobed separator 1300 is preferably constructed from sodium-conducting ceramic materials, but can alternatively be constructed from non-sodium-conducting ceramic materials.

The lobed separator 1300 can be made from and/or include: β-alumina, β″-alumina, Sodium Super Ionic CONductor (NASICON), sodium beta-alumina, sodium beta″-alumina, sodium gadolinium silicate, ceramic-polymer composites, yttria-stabilized zirconia, and/or any other suitable material or combination of materials (e.g., that can conduct sodium ions, lithium ions, potassium ions, oxygen ions, etc.). In an example, the lobed separator 1300 can be a sodium β″-alumina solid electrolyte (BASE). In some variants, the separator material can be doped (e.g., to achieve a desired ionic conductivity, crystal structure, composition, etc.). For instance, β-alumina or β″-alumina can be doped with lithium, magnesium, sodium, and/or other suitable alkali metals, alkaline earth metals, transition metals, and/or other suitable elements.

The thickness (e.g., wall thickness) of the lobed separator 1300 can be between 0.75 mm-4 mm or any range or value therebetween (e.g., 1.0 mm, 1.5 mm, 2 mm, 2.5 mm, 3 mm, 3.25 mm, 3.5 mm). The thickness can alternatively be less than 0.75 mm or greater than 4 mm. The thickness of the lobed separator 1300 can be constant or can vary along the cross-sectional perimeter (e.g., can be thicker in regions expected to experience larger pressure differentials within an electrochemical cell during operation). The thickness of the lobed separator 1300 can be constant or vary (e.g., can be thicker in regions expected to experience larger pressure differentials within an electrochemical cell during operation) along the length of the lobed separator 1300. The lobed separator 1300 is preferably symmetrical (e.g., include a rotational symmetry axis, mirror symmetry, inversion symmetry, etc.). However, the lobed separator can be asymmetrical (e.g., to match a geometry of a housing).

The lobed separator 1300 can withstand a maximum differential pressure (e.g., a burst pressure, etc.) of over 40 psi, 50 psi, 60 psi, 70 psi, over 80 psi, over 90 psi, over 100 psi, over 120 psi, over 150 psi, and/or over any other suitable burst pressure. The differential pressure can refer to a difference in pressure between electrode compartments (e.g., between a cathode compartment and an anode compartment, etc, particularly but not exclusively during charging or discharging of the electrochemical cell). During normal electrochemical cell operation, the burst pressure can range from 5 psi to 45 psi. The separator is preferably designed to withstand at least about 3× the highest normal burst pressure (i.e., at least 115 psi). However, the separator can be designed to withstand exactly the maximum burst pressure, a burst pressure within the range of normal operating burst pressures, and/or greater burst pressures (e.g., for other applications).

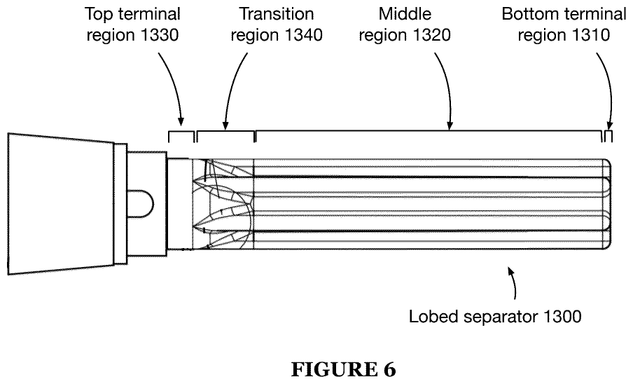

The lobed separator 1300 can be divided into a bottom terminal region 1310 (e.g., the bottom end as defined by a gravity vector, as defined relative to an opening of the electrochemical cell, etc.), a middle region 1320, a top terminal region 1330, and a transition region 1340 (e.g., example shown in FIG. 6, etc.).

The bottom terminal region 1310 preferably has a same or similar cross-sectional profile as a middle region (e.g., a multi-lobe), except without forming a cavity, but can additionally and/or alternatively have any other cross-sectional profile.

In a specific example (as shown for instance in FIG. 5A or FIG. 5B), the bottom terminal region 1310 preferably has a substantially planar section approximately perpendicular to a longitudinal axis of the separator but can additionally and/or alternatively be spherical or have any other shape.

However, the bottom terminal region 1310 may be otherwise configured (e.g., the bottom terminal region can have a similar form as the top terminal region including a transition region to a different shape such as circular, elliptical, or polygonal).

The middle region 1320 can have curves of the cross-sectional profile that can be convex (e.g., forming lobes, etc.) and/or concave (e.g., forming indentations). In an example, the cross-sectional profile can have a perimeter defined by alternating concave and convex curves. In a specific example, the cross-sectional profile can be defined exclusively by curves (e.g., there are no linear perimeter regions lines in the cross-section, etc.).

The middle region 1320 preferably has a lobed (where a lobe can be defined as a convex surface region between two linear, a linear and a concave, and/or two concave regions) cross-sectional profile (e.g., a profile normal to the longitudinal axis of the separator and/or electrochemical cell, etc.), but can additionally and/or alternatively have any other cross-sectional profile. The middle region 1320 can include a lobed cross-sectional profile with any number of lobes greater than 5. The number of lobes can be between 5-1000 or any range or value therebetween (e.g., 6, 10, 20, 50, 100). The number of lobes can alternatively be greater than 1000. For a given span, there is typically a preferred number of lobes that can optimize for separator surface area, burst pressure, wall thickness, ionic conductivity, manufacturability, and/or other properties of the separator. In one illustrative example, for a separator with a maximum span of about 90 mm, the inventors found that a hexalobe separator had the greatest surface area (with the ability to withstand a target burst pressure). In a second illustrative example, for a separator with a maximum span of about 135 mm, the inventors found that an octalobe separator had the greatest surface area (with the ability to withstand a target burst pressure). However, other numbers of lobes can be used for separators with similar spans (e.g., using a different separator thickness, different separator manufacturing processes, different separator materials, etc.).

In a first variant, the lobed cross-sectional profile can be a pentalobe (e.g., has five lobes). In a second variant, the lobed cross-sectional profile can be a hexalobe (e.g., has six lobes). In a third variant, the lobed cross-sectional profile can be a septalobe (e.g., has seven lobes). In a fourth variant, the lobed cross-sectional profile can be an octalobe (e.g., has eight lobes). In a fifth variant, the lobed cross-sectional profile can be a nonalobe (e.g., has nine lobes). In a sixth variant, the lobed cross-sectional profile can be a decalobe (e.g., has ten lobes). In a seventh variant, the lobed cross-sectional profile can be an undecalobe (e.g., has eleven lobes). In a eighth variant, the lobed cross-sectional profile can be a dodecalobe (e.g., has twelve lobes). In an ninth variant, the lobed cross-sectional profile can be a tridecalobe (e.g., has thirteen lobes). In a tenth variant, the lobed cross-sectional profile can be a tetradecalobe (e.g., has fourteen lobes). In a eleventh variant, the lobed cross-sectional profile can be a pentadecalobe (e.g., has fifteen lobes). In an twelfth variant, the lobed cross-sectional profile can be a hexadecalobe (e.g., has sixteen lobes). In a thirteenth variant, the lobed cross-sectional profile can be a heptadecalobe (e.g., has seventeen lobes). In a fourteenth variant, the lobed cross-sectional profile can be an octadecalobe (e.g., has eighteen lobes). In a fifteenth variant, the lobed cross-sectional profile can be a nonadecalobe (e.g., has nineteen lobes). In a sixteenth variant, the lobed cross-sectional profile can be an icosalobe (e.g., has twenty lobes).

Each lobe of the cross-sectional profile of the middle region 1320 is preferably curved or arcuate (which can be beneficial for resisting greater burst pressures compared to linear or pointed regions).

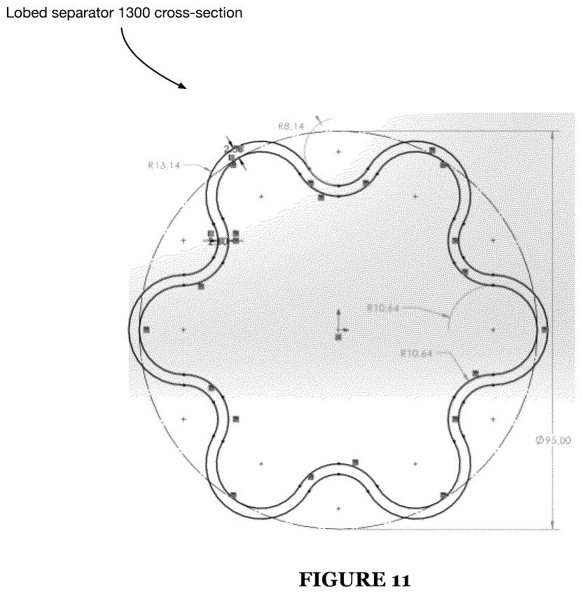

In a first variant, the middle region 1320 can include a lobe cross-sectional profile that includes no straight lines. In an example (as shown for instance in FIG. 11), six curved lobes (e.g., convex regions) and six curved indentations (e.g., concave regions) can exclusively define the cross-sectional profile of the lobed separator. In a second variant, the middle region 1320 can include a lobed cross-sectional profile that includes straight lines between lobe tips (e.g., convex regions) and lobe indentations (e.g., concave regions). In a third variant, the middle region 1320 can include a lobed cross-sectional profile that includes curved lobes (e.g., convex regions) and sharp indentations (e.g., lobes meet each other at an angle) such as having a six-foil cross-sectional geometry.

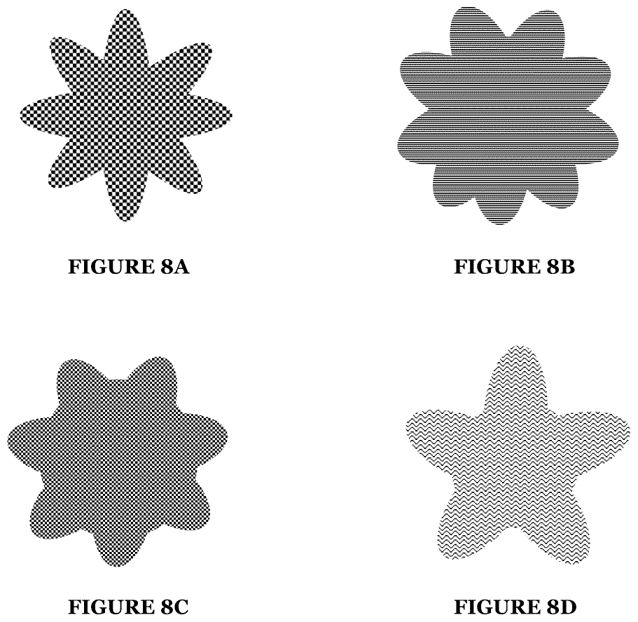

The shape of a concave and/or convex portion of the middle region 1320 can be one of several variants. In a first variant, the portion (e.g., concave portion, convex portion) can be circular (e.g., have a substantially constant curvature over an arc of the lobe and/or indentation, where substantially refers to the fact that at a transition region the radius of curvature is typically smooth and two different constant radii of curvatures would then have a smooth change in radius of curvature in the transition region between the portions). The radius of curvature (e.g., of an outer or inner surface of the lobed separator, etc.) can be 5 mm, 6 mm, 8 mm, 9 mm, 10 mm, 11 mm, 12 mm, 13 mm, 15 mm, 20 mm, 30 mm, a radius of curvature bounded by the aforementioned values and/or any other suitable radius of curvature. The radius of curvature of each indentation can be the same or different as the radius of curvature of each lobe. For example, the ratio of the radius of curvature of an indentation to the radius of curvature of a lobe can be 70%, 80%, 90%, 100%, 110%, 120%, 130%, 140% and/or any other suitable ratio. In a second variant, the shape of the portion (e.g., concave portion, convex portion) can be an amplitude modulated circle (e.g., wherein a radius of the cross-sectional profile varies sinusoidally) and/or can otherwise have a continuously varying radius of curvature. In a third variant, the shape of the portion (e.g., concave portion, convex portion) can be scalloped (e.g. with curved lobes and v-shaped indentations such as a n-foil shape; e.g., example shown in FIG. 8A and FIG. 8B). Alternatively, the shape of the portion (e.g., concave portion, convex portion) can be scalloped with convex or flat indentations (e.g., wherein the indentations are defined by a circular shape, as shown in FIGS. 8C and 8D, etc.). In a fourth variant, the shape of the portion (e.g., concave portion, convex portion) can be parabolic. In a fifth variant, the shape of the portion (e.g., concave portion, convex portion) can be elliptical. In a sixth variant, the shape of the portion (e.g., concave portion, convex portion) can be oval. The shape can additionally and/or alternatively be any other suitable shape.

The first and second derivatives of the curvature around the separator perimeter (e.g., transverse cross-sectional profile) of the middle region 1320 are preferably accurately approximated by a continuous smooth function (which is typically preferred as such functional forms are often tolerant of higher burst pressures). However, the derivatives of the curvature can additionally or alternatively be approximated by noncontinuous and/or nonsmooth functions.

The lobes of the middle region 1320 are preferably evenly-spaced around the perimeter of the cross-sectional profile. However, the lobes can alternatively be unevenly spaced around the perimeter of the cross-sectional profile.

The middle region 1320 can include lobes and indentations of the transverse (e.g., perpendicular to a longitudinal axis) cross-sectional profile that can waver around an underlying shape. In a first variant, the underlying shape can be a circle. In a second variant, the underlying shape can be a triangle. In a third variant, the underlying shape can be a square. In a fourth variant, the underlying shape can be a hexagon. In a fifth variant, the underlying shape can be an octagon. However, any suitable underlying shape can be used. While typically an inner perimeter and an outer perimeter of the transverse cross-sectional profile have the same shape (e.g., substantially the same wall thickness around the cross-sectional profile), they can have different shapes (e.g., nonconstant wall thickness).

The middle region 1320 can have a minimum span of the cross-sectional profile (e.g., distance through the centerline between nearest points of inner surface of the separator) that can be a fraction of the maximum span (e.g., diameter) of the cross-sectional profile (e.g., maximum span of the separator). The fraction can be over 99%, 95%, 90%, 80%, 75%, 70%, 68%, 65%, 60%, 55%, 50%, and/or over any other value. In an example, the fraction can be between any of the aforementioned values and 90%, 80%, or 70%, and/or any other value.

In one illustrative example, a minimum span of the transverse cross-sectional profile passing through a center point of the transverse cross-sectional profile can be between 65% and 90% of the length of a maximum span of the transverse cross-sectional profile, which can provide an optimal surface area relative to burst pressure. However, other ratios could be used (e.g., for different separator thicknesses)

The radial distance between a lobe maximum radius and an indentation minimum radius of the middle region 1320 can be under 5%, 10%, 20%, 30%, 35%, 40%, 45%, 50%, and/or under any other suitable percentage of the maximum span of the separator.

The maximum span of the cross-sectional profile of the middle region 1320 can be equal to the inner span of the housing, 99% of the inner span of the housing, 95% of the inner span of the housing, 90% of the span of the housing, 75% of the inner span of the housing, and/or any other proportion of the inner span of the housing. In an example, the housing can exert force radially inwards on the outer surface of the separator (e.g., directly or indirectly such as mediated by biasing supports).

The perimeter of the cross-sectional profile of the middle region 1320 can be 5%, 10%, 20%, 22%, 25%, 30%, and/or any other suitable percentage higher than a perimeter of a circle with a similar maximum span.

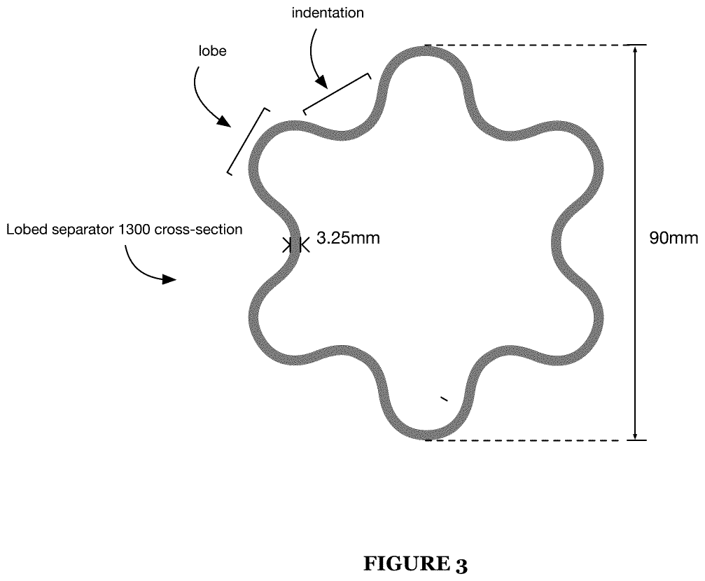

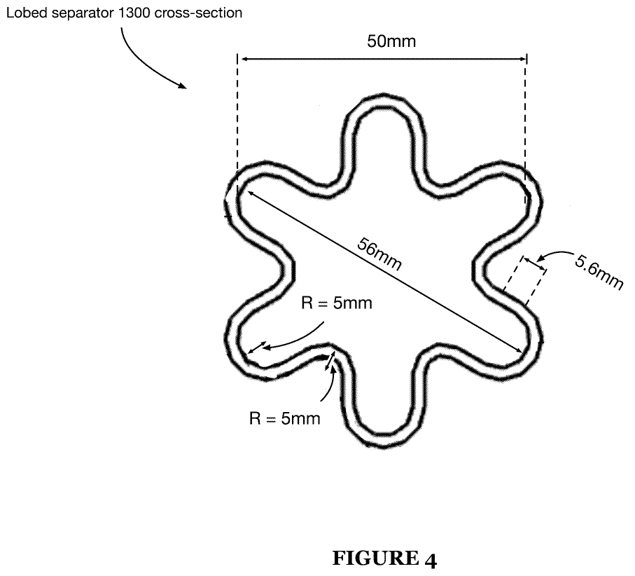

The middle region 1320 can have cross-sectional profile variants (as shown dimensionally for example in FIG. 3, FIG. 4, or FIG. 11).

However, the middle region 1320 may be otherwise configured.

The top terminal region 1330 can have a cross-sectional profile of an open circle, a square, a triangle, a hexagon, and/or any other suitable shape. The shape of the top terminal region 1330 can be the same as the shape of the housing, or alternatively different from the shape of the housing. The shape of the top terminal region 1330 can be the same as the underlying shape of the cross-sectional profile of the middle region, or alternatively different from the underlying shape of the cross-sectional profile of the middle region. The outer span of the top terminal region 1330 can be greater than or equal to the maximum span of the cross-sectional profile of the middle region (e.g., 0% larger, 0.5% larger, 1% larger, 2% larger, 5% larger, within an open or closed range bounded by the aforementioned values, etc.).

The top terminal region 1330 can optionally include (and/or be matingly connected to) a sealing element sealing the cavity formed between the separator and housing (e.g., the outer electrode compartment). The sealing element can include a portion which is electrically connected to all or a subset of biasing supports within the outer electrode compartment, and/or any other electrical connections (e.g., current collectors, external loads or sources, etc.). The sealing element can optionally be a reversible closure assembly sealing the cavity formed by the separator and reversible closure assembly (e.g., the inner electrode compartment).

The top terminal region 1330 can be connected to the middle region directly or via a transition region 1340.

However, the top terminal region 1330 may be otherwise configured.

The transition region 1340 functions to connect the middle section to the top terminal region.

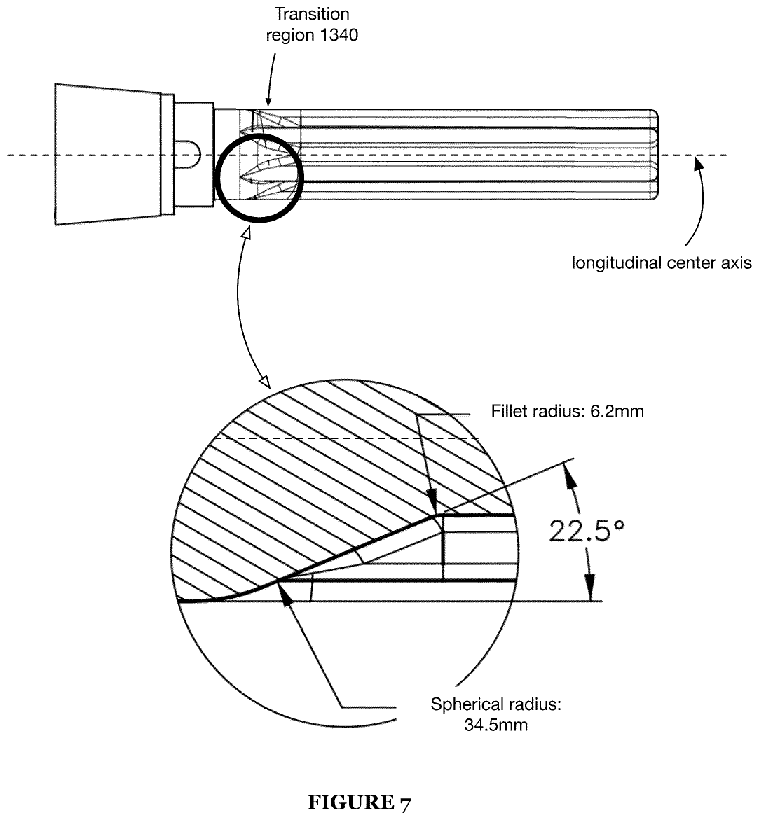

The transition region 1340 can include a transition surface linking the middle section to the top terminal region (e.g., example shown in FIG. 7).

The transition region 1340 can have a conical shape, a lofted shape (e.g., between the middle region cross-sectional profile and the top terminal region cross-sectional profile), a frustum shape (e.g., with a profile with a similar number of faces as the number of lobes of the middle region such as a hexagon for a hexa-lobed middle region, etc.), and/or any other suitable 3D shape.

The angle between the transition surface and the longitudinal axis of the separator in the transition region 1340 is preferably under 23°, but can alternatively be under 25°, under 23°, under 22°, under 21°, under 20°, under 15°, under 10°, and/or under 5°.

The transition between the transition region 1340 and the middle region and/or top terminal region can be soft (e.g., with a fillet, etc.) and/or hard (e.g., non-filleted, etc.). The fillets can have a spherical or cylindrical radius of curvature of 5 mm, 6.2 mm, 8 mm, 10 mm, 15 mm, 20 mm, 30 mm, 34.5 mm, 40 mm, 50 mm, and/or any other suitable radius of curvature.

However, the transition region 1340 may be otherwise configured.

The lobed separator 1300 can have a maximum outer span (e.g., radial diameter perpendicular to the longitudinal axis, etc.) of 50 mm, 60 mm, 70 mm, 80 mm, 90 mm, 100 mm, an outer span within an open or closed range bounded by the aforementioned values, and/or any other suitable outer span (e.g., depending on a size of the electrochemical cell).

The maximum outer span of the lobed separator 1300 can be the maximum outer span of the overall lobed separator, the maximum outer span of the middle section of the lobed separator, the maximum outer span of the top terminal region, and/or the maximum outer span of any other portion of the lobed separator.

In a first variant, the lobed separator 1300 can have a top terminal region and middle region with the same maximum outer span (despite having different geometries).

In a second variant, the lobed separator 1300 can have a top terminal region and middle region with different maximum outer spans.

The lobed separator 1300 can be formed by different processes. In a first variant, the lobed separator 1300 can be formed by pressing followed by sintering, without calcining, a sodium aluminate powder. In a second variant, the lobed separator 1300 can be formed by pressing followed by sintering, then calcining, a sodium aluminate powder. In a third variant, the lobed separator 1300 can be formed by pressing followed by sintering, then calcining, followed by a final sintering of, a sodium aluminate powder. In a fourth variant, the lobed separator 1300 can be formed by calcining, then sintering, a sodium aluminate powder. The lobed separator 1300 can involve a calcining process. In variants, the calcining process can be a single phase of calcination, a two-phase calcination, and/or can involve any other number of calcination steps. In an example, the calcining process can include a first calcination step between 110° and 1300° C. and a second calcination step between 1300-1500° C. The lobed separator 1300 can be formed using a mold. In an example, the lobed separator can be slightly tapered (e.g., 0.05°, etc.) to facilitate removal from the mold.

However, the lobed separator 1300 may be otherwise configured.

The housing 1400 can function to contain and/or protect components of the electrochemical cell (e.g., from an external environment, from mechanical impacts, etc.). The housing 1400 can be made of steel (e.g., stainless steel, carbon steel, etc.), aluminum, ceramics, nickel, and/or any other materials (where when an electrically conductive material is used the housing, or a portion thereof, can act as a lead, tab, or other electrical contact point). The housing 1400 can have a circular cross-section (e.g., cylindrical shape), a hexagonal cross-section (e.g., prismatic shape), a square cross section (e.g., prismatic shape), a cross-section substantially identical to or complimentary to (e.g., including the same number of corners, edges, etc. as the number of lobes of) the lobed separator (e.g., prismatic shape), and/or any other cross-section shape and/or 3D geometry.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

We claim:

1. An electrochemical cell, comprising:
a housing defining a cell volume;
a sodium-conducting ceramic separator arranged within the housing, wherein at least five convex curves and at least five concave curves define a closed transverse cross-sectional profile of the sodium-conducting ceramic separator, wherein the transverse cross-sectional profile is perpendicular to a longitudinal axis of the sodium-conducting ceramic separator, and wherein the sodium-conducting ceramic separator divides the cell volume into:
a negative electrode containing an alkali metal; and
a positive electrode containing a transition metal halide;
a flexible sheet wrapped around the sodium-conducting ceramic separator; and
a set of biasing supports between the flexible mesh and the housing, the set of biasing supports conform the flexible sheet to the sodium-conducting ceramic separator.

2. The electrochemical cell of claim 1, wherein the transverse cross-sectional profile does not have a straight perimeter portion.

3. The electrochemical cell of claim 1, wherein a minimum span of the transverse cross-sectional profile passing through a center point of the transverse cross-sectional profile is between 50% and 90% of the length of a maximum span of the transverse cross-sectional profile.

4. The electrochemical cell of claim 1, wherein the sodium-conducting ceramic separator comprises a top terminal region and a transition region connecting the top terminal region to a middle region of the sodium-conducting ceramic separator, where a symmetry of the top terminal region is substantially the same as a symmetry of the transverse cross-sectional profile.

5. The electrochemical cell of claim 4, wherein the top terminal region has an elliptical cross-section.

6. The electrochemical cell of claim 1, wherein a biasing support of the set of biasing supports applies an alignment force to a minimum-radius or maximum-radius point on a surface of the sodium-conducting ceramic separator.

7. The electrochemical cell of claim 1, wherein the sodium-conducting ceramic separator comprises a bottom terminal region with a flat portion perpendicular to the longitudinal axis.

8. The electrochemical cell of claim 1, wherein during discharging of the electrochemical cell, a maximum differential pressure between the anode region and cathode region is between 5 psi and 45 psi.

9. The electrochemical cell of claim 1, wherein the housing comprises substantially the same symmetry as the transverse cross-sectional profile.

10. A system comprising: an alkali metal-conducting ceramic material, wherein at least five convex curves and at least five concave curves define a closed transverse cross-sectional profile of the alkali metal-conducting ceramic material, wherein the transverse cross-sectional profile is perpendicular to a longitudinal axis of the alkali metal-conducting ceramic material.

11. The system of claim 10, wherein the transverse cross-sectional profile does not have a linear perimeter region.

12. The system of claim 10, wherein a minimum span of the transverse cross-sectional profile passing through a center point of the transverse cross-sectional profile is between 50% and 90% of the length of a maximum span of the transverse cross-sectional profile.

13. The system of claim 10, wherein the alkali metal-conducting ceramic material comprises a top terminal region with a circular cross-section and a transition region connecting the top terminal region to a middle region of the alkali metal-conducting ceramic material which has the transverse cross-sectional profile.

14. The system of claim 13, wherein a half-angle of a conical surface of the transition region is under 50°.

15. The system of claim 10, wherein the sodium-conducting ceramic separator comprises a bottom terminal region with a flat portion perpendicular to the longitudinal axis.

16. The system of claim 10, wherein the alkali metal-conducting ceramic comprises β-alumina or β″-alumina.

17. The system of claim 10, further comprising a flexible sheet in contact with surfaces of the at least six convex curves and surfaces of the at least six concave curves of the alkali metal-conducting ceramic material.

18. The system of claim 17, further comprising a set of biasing supports radially outwards from the flexible sheet relative to the longitudinal axis, wherein a biasing support of the set of biasing supports conform the flexible sheet to a surface of the alkali metal-conducting ceramic material.

19. The system of claim 18, wherein the biasing support of the set of biasing supports directly contacts a minimum-radius or maximum-radius point on the surface of the alkali metal-conducting ceramic material.

20. The system of claim 18, wherein biasing supports of the set of biasing supports differ in transverse cross-sectional area.

21. The system of claim 10, further comprising a set of biasing supports, wherein the set of biasing supports conform to a surface of the alkali metal-conducting ceramic material.

22. The system of claim 10, further comprising a housing with the same symmetry as the transverse cross-sectional profile, wherein the alkali metal-conducting ceramic material is arranged within the housing.

23. The system of claim 22, wherein the housing comprises a circular cross-sectional profile.

24. The system of claim 10, wherein a wall thickness of the alkali metal-conducting ceramic material is between 0.5 and 5 mm.

25. The system of claim 10, wherein a burst pressure of the alkali metal-conducting ceramic material is between 40 psi and 120 psi.
